(19) United States
(12) Patent Application Publication
(10) Pub. No.: US 2018/0003138 A1
(43) Pub. Date: Jan. 4, 2018

(54) HIGH-PRESSURE PUMP AND PRODUCTION METHOD THEREOF

(71) Applicant: DENSO CORPORATION, Kariya-city, Aichi-pref. (JP)

(72) Inventor: Masaharu NAKAOKA, Kariya-city (JP)

(21) Appl. No.: 15/543,756

(22) PCT Filed: Dec. 22, 2015
(86) PCT No.: PCT/JP2015/006378

§ 371 Date: Jul. 14, 2017

(30) Foreign Application Priority Data
Jan. 20, 2015 (JP) 2015-008333

(51) Int. Cl. F02M 59/48; F02M 59/10; F02M 59/02

(52) U.S. Cl. CPC F02M 59/48; F02M 59/025; F02M 59/102

(57) ABSTRACT

A pump body of a high-pressure pump includes a pressure chamber formed in a deep portion of a cylinder. A plunger reciprocates within the cylinder to vary a volume of the pressure chamber. A discharge path and a supply path are formed in the pump body and extend in a radial direction of the cylinder from the pressure chamber. A pin provided at an end of the plunger in the pressure chamber protrudes in one radial direction of the plunger to the outside of an inner circumference of the cylinder. In this case, the pin is engaged with a step portion between the cylinder and the pressure chamber in a state before attachment of the high-pressure pump to an internal combustion engine. Accordingly, separation of the plunger from the cylinder is avoidable.

### CROSS-REFERENCE TO RELATED APPLICATION

This application is based on Japanese Patent Application No. 2015-8333 filed on Jan. 20, 2015, the disclosure of which is incorporated herein by reference.

### TECHNICAL FIELD

The present disclosure relates to a high-pressure pump for an internal combustion engine, and to a production method of the high-pressure pump.

### BACKGROUND ART

A high-pressure pump provided in a fuel supply system has been known. The high-pressure pump pressurizes fuel in the system to supply the pressurized fuel to an internal combustion engine.

The high-pressure pump pressurizes the fuel by varying a volume of a pressure chamber formed in a deep portion of a cylinder in accordance with reciprocating movement of a plunger provided inside the cylinder. The fuel pressurized by the pressure chamber is discharged from a discharge path communicating with the pressure chamber.

According to an example of a high-pressure pump described in Patent Literature 1, a ring-shaped member fits to a radially outer portion of a plunger on the side exposed to a pressure chamber. This high-pressure pump prevents separation of the plunger from a cylinder by engagement between the ring-shaped member and a step portion formed between the pressure chamber and the cylinder in a state before attachment to an internal combustion engine.

According to another example of the high-pressure pump described in Patent Literature 1, the outside diameter of the plunger at a portion protruding from the cylinder toward the side opposite to the pressure chamber is smaller than the outside diameter of the plunger at a portion inside the cylinder. The plunger therefore has a step at the portion corresponding to the change of the outside diameter of the plunger. This high-pressure pump similarly prevents separation of the plunger from the cylinder by engagement between the step of the plunger and a step portion of a pump body in a state before attachment to an internal combustion engine.

According to the high-pressure pump described in Patent Literature 1, a suction valve unit that controls supply of fuel to the pressure chamber is provided on the pressure chamber on the side opposite to the plunger. The suction valve unit is detachably attached to the pump body. This configuration of the high-pressure pump allows insertion of the plunger from the pressure chamber into the cylinder before assembly of the suction unit to the pump body.

According to the high-pressure pump described in Patent Literature 1, however, the size of the high-pressure pump in the axial direction of the cylinder increases by the presence of the suction valve unit described above. When the position of the suction valve unit of the high-pressure pump described in Patent Literature 1 is switched to a position in the radial direction of the cylinder, and the pressure chamber on the side opposite to the plunger is closed by the pump body, for example, assembly of the plunger to the cylinder from an opening of the cylinder on the side opposite to the pressure chamber is difficult in any of the examples described above.

### PRIOR ART LITERATURES

### Patent Literature

PATENT LITERATURE 1: JP 2003-65175 A

### SUMMARY OF INVENTION

It is an object of the present disclosure to provide a high-pressure pump capable of preventing separation of a plunger regardless of an assembly direction of the plunger to a cylinder, and to provide a production method of this high-pressure pump.

A high-pressure pump includes a cylinder, a pump body, a plunger, a fuel path, and a protrusion portion.

The pump body includes a pressure chamber having an inside diameter larger than an inside diameter of the cylinder, and disposed in a deep portion of the cylinder. The plunger reciprocates within the cylinder to vary a volume of the pressure chamber. The fuel path formed in the pump body extends in a radial direction of the cylinder from the pressure chamber. The protrusion portion protrudes in one radial direction from a pressure chamber side end of the plunger to the outside of an inner circumference of the cylinder.

According to this structure, the protrusion portion is engaged with a step portion between the cylinder and the pressure chamber in a state before attachment of the high-pressure pump to an internal combustion engine. Accordingly, separation of the plunger from the cylinder can be prevented.

A production device of a high-pressure pump includes an installation table and a first jig. The installation table is a table on which the pump body is installed. The first jig is inserted from the fuel path toward the pressure chamber to form the protrusion portion at the end of the plunger on the side protruding to the pressure chamber.

A production method of a high-pressure pump includes an insertion process and a protrusion portion formation process. In the insertion step, the plunger is inserted into the cylinder. In the protrusion portion formation step, the first jig is inserted from the fuel path toward the pressure chamber to form the protruding portion at the end of the plunger on the side protruding to the pressure chamber.

According to the production device and the production method described above, the protrusion portion is formed at the end of the plunger even in the high-pressure pump configured such that the pressure chamber on the side opposite to the plunger is closed by the pump body.

### BRIEF DESCRIPTION OF DRAWINGS

The above and other objects, features, and advantages of the present disclosure will become more apparent from the following detailed description made with reference to the accompanying drawings.

FIG. 1 is a cross-sectional view of a high-pressure pump according to a first embodiment of the present disclosure.

FIG. 2 is an enlarged view of a part II in FIG. 1.

FIG. 3 is a flowchart showing a production process of the high-pressure pump according to the first embodiment.

FIG. 4 is a cross-sectional view illustrating a state of the high-pressure pump during production.

FIG. 5 is a cross-sectional view of a plunger and the like taken along a line V-V in FIG. 4.

FIG. 6 is a cross-sectional view illustrating a state of the high-pressure pump during production.

FIG. 7 is a cross-sectional view illustrating a state of the high-pressure pump during production.

FIG. 8 is an enlarged view of a part VIII in FIG. 7.

FIG. 9 is a cross-sectional view of the high-pressure pump in a state for attachment to an internal combustion engine.

FIG. 10 is an enlarged view of a part X in FIG. 9.

FIG. 11 is a partial cross-sectional view of a high-pressure pump according to a second embodiment of the present disclosure.

FIG. 12 is a cross-sectional view of a plunger and the like taken along a line XII-XII in FIG. 11.

FIG. 13 is a flowchart showing a production process of the high-pressure pump according to the second embodiment.

FIG. 14 is a cross-sectional view illustrating a state of the high-pressure pump during production.

FIG. 15 is a cross-sectional view taken along a line XV-XV in FIG. 14.

FIG. 16 is a partial cross-sectional view of a high-pressure pump according to a third embodiment of the present disclosure.

FIG. 17 is a cross-sectional view of a plunger and the like taken along a line XVII-XVII in FIG. 16.

FIG. 18 is a flowchart showing a production process of the high-pressure pump according to the third embodiment.

FIG. 19 is a cross-sectional view illustrating a state of the high-pressure pump during production.

FIG. 20 is a cross-sectional view of a high-pressure pump of a first comparative example in a state for attachment to an internal combustion engine.

FIG. 21 is a cross-sectional view of a high-pressure pump of a second comparative example in a state for attachment to an internal combustion engine.

### EMBODIMENTS FOR CARRYING OUT INVENTION

A plurality of embodiments according to the present disclosure are hereinafter described with reference to the drawings. Note that substantially identical configurations in the plurality of embodiments have been given identical reference numbers. The same explanation is not repeated for the identical configurations.

### First Embodiment

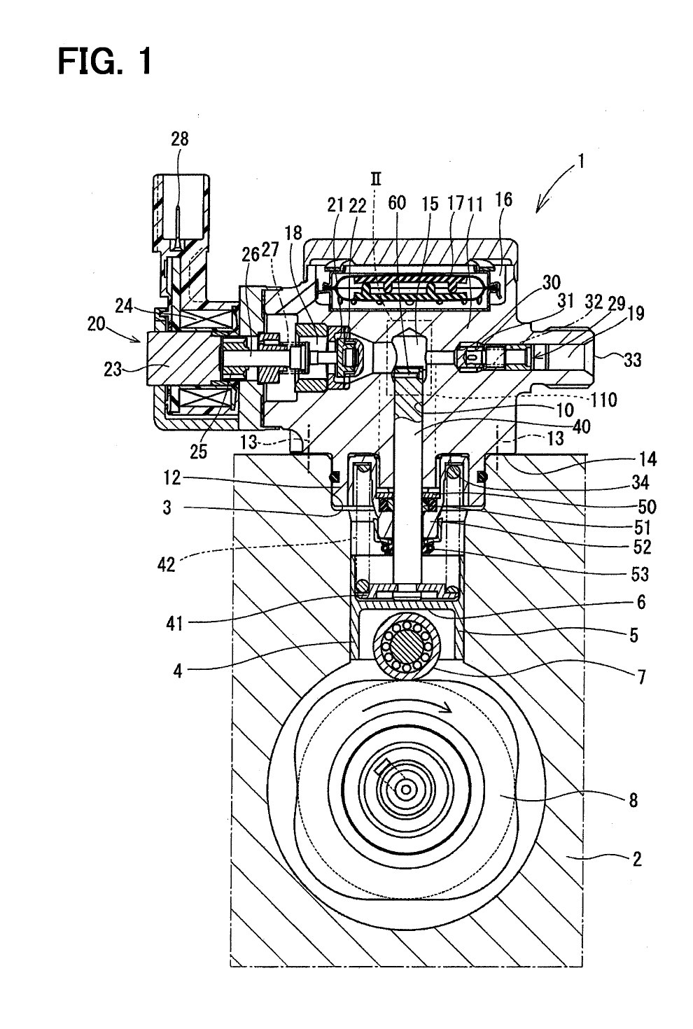

FIGS. 1 to 10 illustrate a high-pressure pump according to a first embodiment of the present disclosure. A high-pressure pump 1 according to the present embodiment is attached to an engine block 2 of an internal combustion engine, pressurizes fuel drawn from a fuel tank, and pumps the fuel to a delivery pipe. The fuel accumulated in the delivery pipe is injected and supplied from an injector to cylinders of the internal combustion engine.

As illustrated in FIG. 1, the high-pressure pump 1 includes a cylinder 10, a pump body 11, a plunger 40, a supply path 18, a discharge path 19, and a pin 60 corresponding to a column-shaped member, and others.

In FIG. 1, a conceptual boundary between the cylinder 10 and the pump body 11 is indicated by a broken line 110. However, the cylinder 10 and the pump body 11 in the present embodiment are formed integrally. The cylinder 10 and the pump body 11 may be configured by separate bodies.

The pump body 11 includes a fitting portion 12 having a cylindrical shape and capable of fitting to a bore 3 formed in the engine block 2 of the internal combustion engine. The pump body 11 is fixed to the engine block 2 by a bolt (not shown) provided at a position indicated by a chain line 13 in FIG. 1. In this condition, a contact surface 14 provided outside the fitting portion 12 contacts the engine block 2.

The pump body 11 includes a pressure chamber 15 formed in a deep portion of the cylinder 10. The pressure chamber 15 on the side opposite to the plunger 40 is closed by the pump body 11.

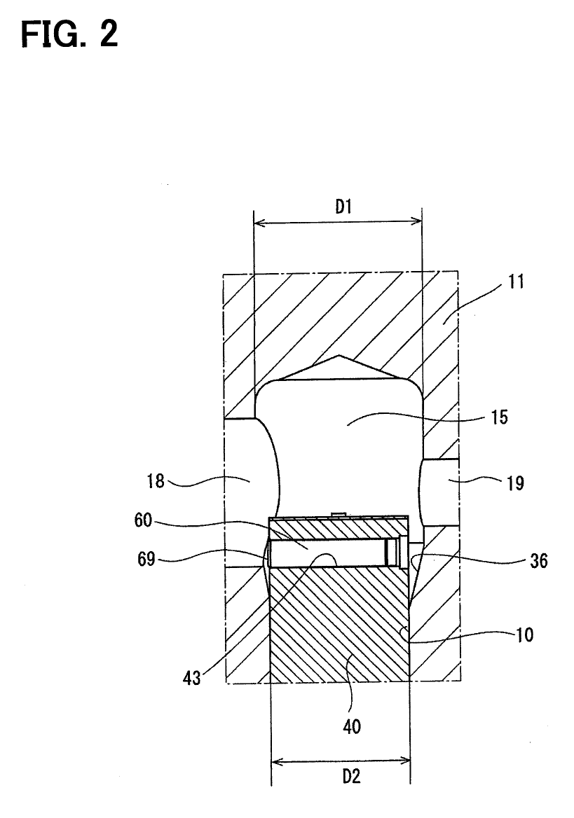

As illustrated in FIG. 2, an inside diameter D1 of the pressure chamber 15 is slightly larger than an inside diameter D2 of the cylinder 10. Accordingly, a step portion 36 having a tapered-shape is formed at a connection portion between the pressure chamber 15 and an inner wall of the cylinder 10.

As illustrated in FIG. 1, a damper chamber 16 is formed in the pump body 11 on a side opposite to the cylinder 10 of the pressure chamber 15. The damper chamber 16 includes a pulsation damper 17. The pulsation damper 17 contains gas having a predetermined pressure and sealed between two metal diaphragms, and reduces fuel pressure pulsation of the damper chamber 16 by elastic deformation of the two metal diaphragms in accordance with a pressure change of the damper chamber 16.

The pump body 11 includes the supply path 18 and the discharge path 19 each of which extends in a radial direction of the cylinder 10 from the pressure chamber 15. According to the present embodiment, the discharge path 19 corresponds to a “fuel path”, and the supply path 18 corresponds to a “second fuel path”.

A suction valve unit 20 is provided in the supply path 18. The suction valve unit 20 connects or separates the pressure chamber 15 and the supply path 18 by separating or connecting a suction valve 22 from and to a valve seat 21 formed in the supply path 18. Driving of the suction valve 22 is controlled by an electromagnetic driving unit. The electromagnetic driving unit is configured by a fixed core 23, a coil 24, a movable core 25, a shaft 26, a spring 27, and others. The suction valve 22 in the present embodiment is a normally open type. When power is supplied from a connector terminal 28 to the coil 24, magnetic force thus generated attracts the movable core 25 toward the fixed core 23 while resisting urging force of the spring 27, thereby achieving cancellation of urging force of the shaft 26 urging the suction valve 22 in a valve opening direction.

A discharge valve unit 29 is provided in the discharge path 19. The discharge valve unit 29 connects or separates the pressure chamber 15 and the discharge path 19 by separating or connecting a discharge valve 31 from and to a valve seat 30 formed in the discharge path 19. The discharge valve 31 is separated from the valve seat 30 when force applied to the discharge valve 31 from fuel on the pressure chamber 15 side exceeds the sum of force applied to the discharge valve 31 from fuel on the downstream side of the valve seat 30 and elastic force of the spring 32. As a result, fuel in the pressure chamber 15 passes through the discharge path 19 to the outside from a fuel outlet 33.

The plunger 40 is accommodated inside the cylinder 10 formed into a cylindrical shape so as to reciprocate in the axial direction. The plunger 40 moves toward the damper chamber 16 to decrease the volume of the pressure chamber 15 and pressurize fuel. The plunger 40 also moves toward the side opposite to the damper chamber 16 to increase the volume of the pressure chamber 15 and suctions fuel from the supply path 18 into the pressure chamber 15.

A spring seat 41 is fixed to an end of the plunger 40 on the side opposite to the pressure chamber 15. A plunger spring 42 is provided between the spring seat 41 and a holder 52 fixed to the pump body 11. The plunger spring 42 and the spring seat 41 urge the plunger 40 to the side opposite to the pressure chamber 15. The spring seat 41 engages with a lifter 4 inserted into a bore 3 of the internal combustion engine.

The lifter 4 includes a cylindrical portion 5 having a cylindrical shape, a partitioning plate 6 disposed at an axially intermediate portion of the cylindrical portion 5, and a roller 7 disposed on the side opposite to the spring seat 41 with the partitioning plate 6 interposed between the spring seat 41 and the roller 7. An outer wall of the cylindrical portion 5 is in sliding contact with an inner wall of the bore 3 of the internal combustion engine. The roller 7 comes in sliding contact with a cam 8 provided in a deep portion of the bore 3 of the internal combustion engine. The cam 8 rotates with a cam shaft or a crank shaft provided to drive a suction valve or a discharge valve of the internal combustion engine. Rotation of the cam 8 reciprocates the lifter 4 inside the bore 3, thereby reciprocating the plunger 40 in the axial direction in the cylinder 10 by contact between the plunger 40 and the partitioning plate 6 of the lifter 4.

A spacer 50 having an annular shape is provided at an end of the cylinder 10 on the side opposite to the pressure chamber 15. A fuel seal 51 is provided on the spacer 50 on the side opposite to the pressure chamber 15. The fuel seal 51 regulates a thickness of a fuel film around the plunger 40 to reduce leak of fuel toward the internal combustion engine caused by sliding of the plunger 40.

A holder 52 is provided on the fuel seal 51 on the side opposite to the pressure chamber 15. The holder 52 is extended toward the pump body 11, and fixed to a recess portion 34 formed in the pump body 11 around the cylinder 10.

An oil seal 53 is attached to an end of the holder 52 on the side opposite to the pressure chamber 15. The oil seal 53 regulates a thickness of an oil film around the plunger 40 to reduce entrance of oil from the internal combustion engine caused by sliding of the plunger 40.

As illustrated in FIG. 2, a hole 43 is formed at an end of the plunger 40 on the side protruding to the pressure chamber 15. The hole 43 penetrates the plunger 40 in the direction perpendicular to an axis of the plunger 40. A pin 60 corresponding to a column-shaped member is press-fitted and fixed into the hole 43. The pin 60 protrudes in one radial direction from the outer wall of the plunger 40.

A portion 69 configured by this protrusion portion corresponds to a “protrusion portion”.

The pin 60 protrudes to the outside from an inner circumference of the cylinder 10 to an extent not contacting the inner wall of the pressure chamber 15. In this case, the pin 60 is engaged with the step portion 36 connecting the cylinder 10 and the pressure chamber 15 in a state before attachment of the high-pressure pump 1 to the inner combustion engine. Accordingly, prevention of separation of the plunger 40 from the cylinder 10, and retention of a compressed state of the plunger spring 42 are both achievable.

A production device of the high-pressure pump 1 is hereinafter described with reference to FIGS. 4 to 8.

A production device of the high-pressure pump 1 includes an installation table 70, a first jig 71, and a second jig 72.

The installation table 70 is a table on which the pump body 11 of the high-pressure pump 1 is installed.

The first jig 71 is a jig inserted from the discharge path 19 toward the pressure chamber 15 of the high-pressure pump 1. As illustrated in FIG. 8, the outside diameter of a tip portion 73 of the first jig 71 is smaller than the inside diameter of the hole 43 of the plunger 40. Accordingly, the tip of the pin 60 press-fitted into the hole 43 of the plunger 40 is allowed to be pushed by the first jig 71 to the outside from the outer wall of the plunger 40.

As illustrated in FIG. 6, the second jig 72 is formed integrally with the installation table 70. The second jig 72 is a jig inserted from the supply path 18 into the pressure chamber 15. The second jig 72 includes a positioning portion 74 brought into contact with the axial end of the plunger 40 within the pressure chamber 15. Accordingly, the axial position of the plunger 40 is determined by contact between the positioning portion 74 and the second jig 72 and the plunger 40.

As illustrated in FIG. 8, the second jig 72 includes a recess portion 75 in a surface in contact with the radially outer wall of the plunger 40. The recess portion 75 is recessed by a predetermined amount from the outer wall of the plunger 40. The recess portion 75 of the second jig 72 regulates a protruding amount of the pin 60 protruding to the outside from the outer wall of the plunger 40.

According to this configuration of the production device, the pin 60 press-fitted into the plunger 40 of the high-pressure pump 1 is allowed to protrude by the predetermined amount from the outer wall of the plunger 40. The protruded portion of the pin 60 has the portion 69 protruding by the predetermined amount from the outer wall of the plunger 40.

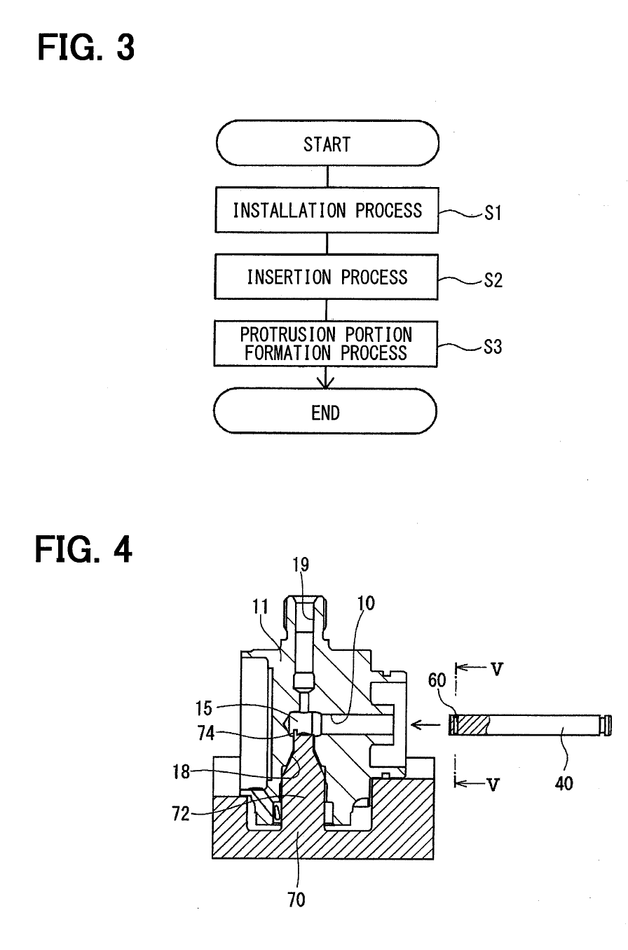

A production method of the high-pressure pump 1 is now described with reference to FIGS. 3 to 8.

Each step in the flowchart is expressed as “S” in the figure.

In an initial installation process of S1, as illustrated in FIG. 4, the pump body 11 is installed on the installation table 70, and the second jig 72 is inserted into the pressure chamber 15 from the supply path 18.

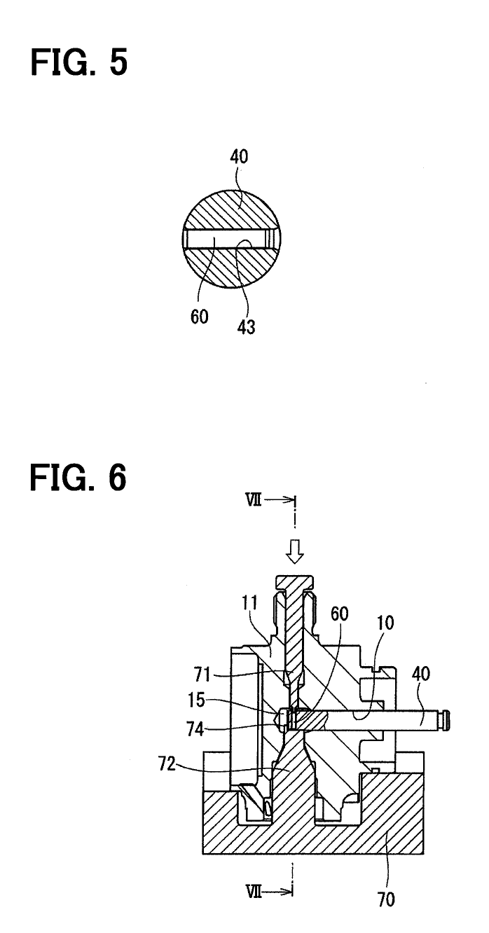

In an insertion process of S2, the plunger 40 is inserted into the cylinder 10 as indicated by an arrow in FIG. 4. In this step, both the axial ends of the pin 60 are accommodated inside the hole 43 of the plunger 40 without protruding to the outside from the outer wall of the plunger 40 as illustrated in FIG. 5.

When the plunger 40 is inserted into the pressure chamber 15 from the cylinder 10 as illustrated in FIG. 6, the axial end of the plunger 40 contacts the positioning portion 74 of the second jig 72 to determine the axial position of the plunger 40.

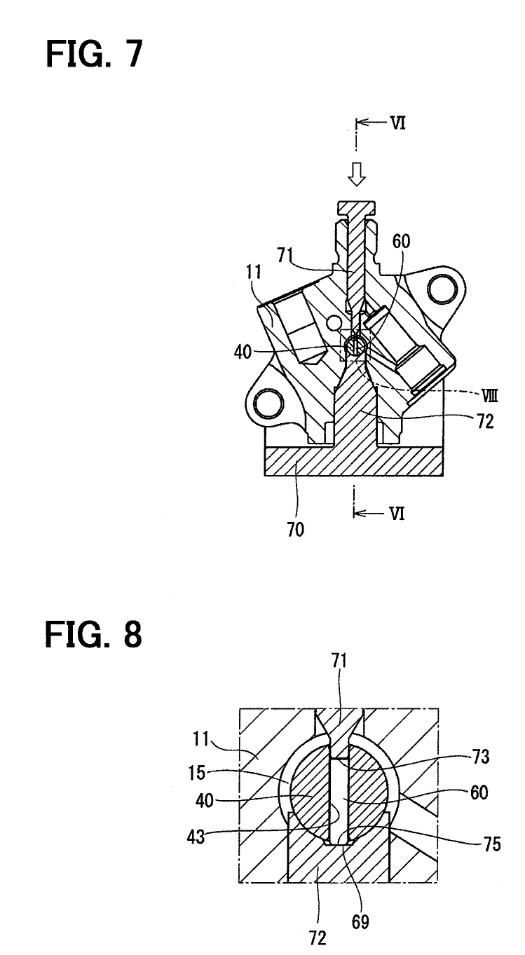

In a protrusion portion formation process of S3, the first jig 71 is inserted from the discharge path 19 toward the pressure chamber 15 to fit the tip portion 73 of the first jig 71 into the hole 43 of the plunger 40. Thereafter, the pin 60 is pressed by the tip portion 73 of the first jig 71 as illustrated in FIGS. 7 and 8. As a result, the tip of the pin 60 on the side opposite to the first jig 71 is pushed out from the hole 43 of the plunger 40. In this case, the tip of the pin 60 pushed out from the hole 43 of the plunger 40 contacts the recess portion 75 of the second jig 72. The protruding amount of the protrusion portion 69 of the pin 60 from the outer wall of the plunger 40 is thus regulated.

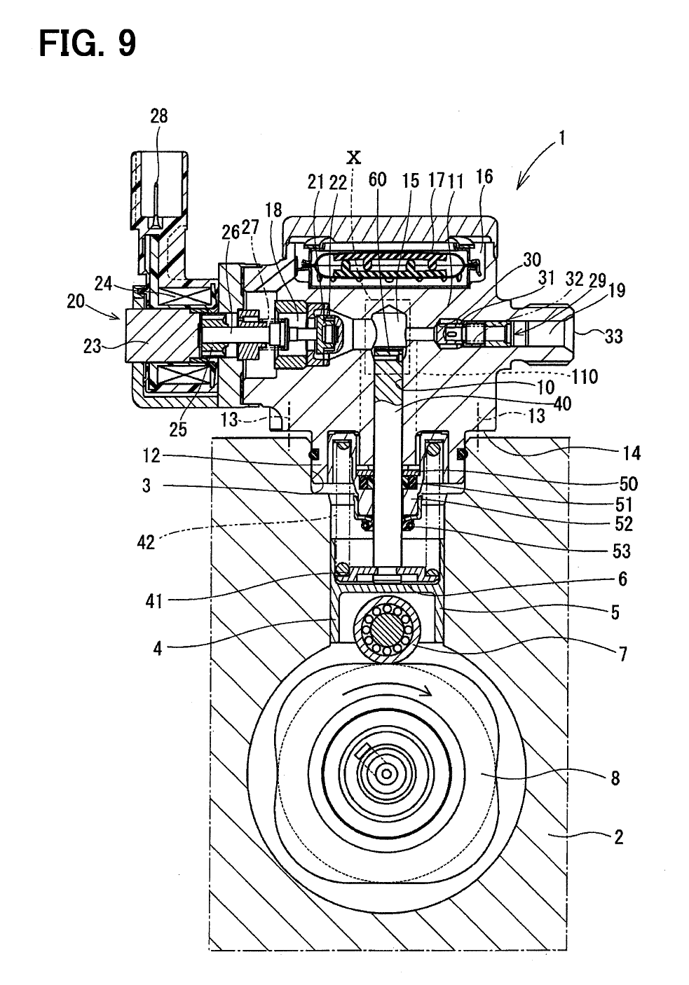

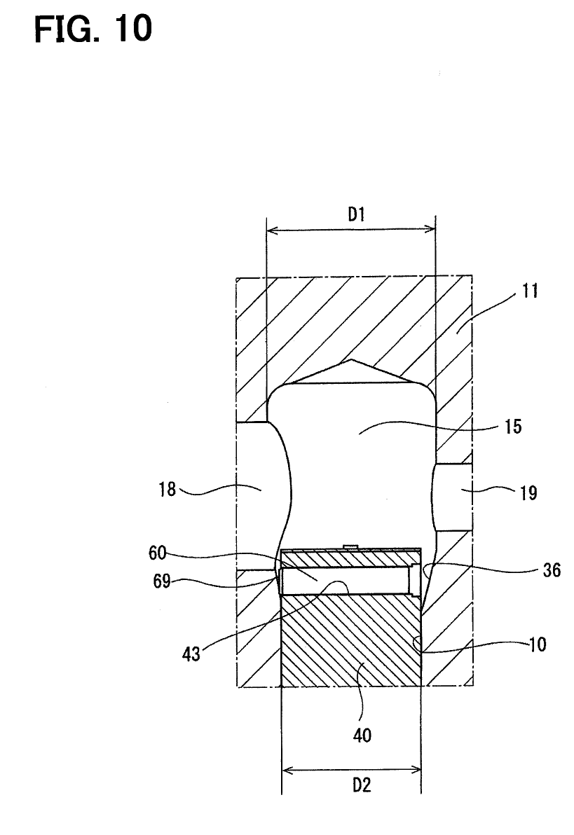

Thereafter, the high-pressure pump 1 is attached to the bore 3 formed in the engine block 2 of the internal combustion engine as illustrated in FIGS. 9 and 10. FIGS. 9 and 10 illustrate a state of the pump body 11 before fastened to the engine block 2 via a bolt 13. In this state, the pin 60 is engaged by the step portion 36 between the pressure chamber 15 and the cylinder 10, and the plunger spring 42 is compressed by a predetermined amount. The fitting portion 12 of the pump body 11 is therefore fitted into the bore 3 of the engine block 2. In this case, the compression amount of the plunger spring 42 necessary for fastening by the bolt decreases. Accordingly, the pump body 11 is fastened to the engine block 2 by the bolt more easily.

Following advantageous effects are offered in the first embodiment.

(1) According to the high-pressure pump 1 of the first embodiment, the pin 60 provided at end of the plunger 40 in the pressure chamber 15 protrudes in one radial direction from the outer wall of the plunger 40 to the outside of the inner circumference of the cylinder 10.

In this case, the pin 60 is engaged with the step portion 36 formed between the cylinder 10 and the pressure chamber 15 in a state before attachment of the high-pressure pump 1 to the internal combustion engine. Accordingly, separation of the plunger 40 from the cylinder 10 is avoidable. Assembly to the pump body 11 is therefore allowed in a state that the plunger spring 42 is compressed by a predetermined amount according to the high-pressure pump 1. In this case, the additional compression length the plunger spring 42 necessary for fastening the high-pressure pump 1 to the internal combustion engine by the bolt decreases, and therefore work efficiency increases.

(2) According to the high-pressure pump 1 of the first embodiment, the pump body 11 closes the pressure chamber 15 on the side opposite to the plunger 40.

In this case, the suction valve unit 20 for supplying fuel to the pressure chamber 15 is not located in the pressure chamber 15 on the side opposite to the plunger 40 in the high-pressure pump 1. Accordingly, the axial size of the cylinder 10 of the high-pressure pump 1 decreases.

(3) According to the high-pressure pump 1 of the first embodiment, the pin 60 corresponding to the column-shaped member is press-fitted and fixed to the hole 43 formed at the end of the plunger 40 on the side protruding to the pressure chamber 15.

Accordingly, the pin 60 is easily fixed to the plunger 40.

(4) According to the production device of the high-pressure pump 1 of the first embodiment, the pin 60 press-fitted into the hole 43 of the plunger 40 is pushed out from the hole 43 of the plunger 40 by the first jig 71 inserted from the discharge path 19 toward the pressure chamber 15.

Accordingly, the pin 60 protrudes from the hole 43 of the plunger 40 even when the high-pressure pump 1 is configured such that the pressure chamber 15 on the side opposite to the plunger 40 is closed by the pump body 11.

(5) According to the production device of the high-pressure pump 1 of the first embodiment, the second jig 72 inserted into the pressure chamber 15 from the discharge path 19 includes the positioning portion 74 in contact with the axial end of the plunger 40.

In this case, the axial position of the plunger 40 is determined by contact between the positioning portion 74 and the plunger 40. Accordingly, the tip portion 73 of the first jig 71 is easily inserted into the hole 43 of the plunger 40.

(6) According to the production device of the high-pressure pump 1 of the first embodiment, the second jig 72 includes the recess portion 75 that regulates the protruding amount of the pin 60 protruding to the outside from the outer wall of the plunger 40.

In this case, the protruding amount of the pin 60 is accurately determined. Accordingly, contact between the inner wall of the pressure chamber 15 and the pin 60 is avoidable during use of the high-pressure pump 1.

(7) According to the production method of the high-pressure pump 1 of the first embodiment, the first jig 71 is inserted from the discharge path 19 toward the pressure chamber 15, and then the pin 60 press-fitted into the hole 43 of the plunger 40 is pushed out from the hole 43 in the protrusion portion formation step.

Accordingly, the pin 60 protrudes from the hole 43 of the plunger 40 even when the high-pressure pump 1 is configured such that the pressure chamber 15 on the side opposite to the plunger 40 is closed by the pump body 11.

(8) According to the production method of the high-pressure pump 1 of the first embodiment, the axial position of the plunger 40 is determined by bringing the plunger 40 and the positioning portion 74 included in the second jig 72 into contact with each other in the insertion step.

Accordingly, the tip portion 73 of the first jig 71 is easily inserted into the hole 43 of the plunger 40.

(9) According to the production method of the high-pressure pump 1 of the first embodiment, the pin 60 is brought into contact with the recess portion 75 included in the second jig 72 in the protrusion portion formation step.

In this case, the protruding amount of the pin 60 is accurately regulated. Accordingly, contact between the inner wall of the pressure chamber 15 and the protrusion portion 69 of the pin 60 is avoidable during use of the high-pressure pump 1.

### First Comparative Example

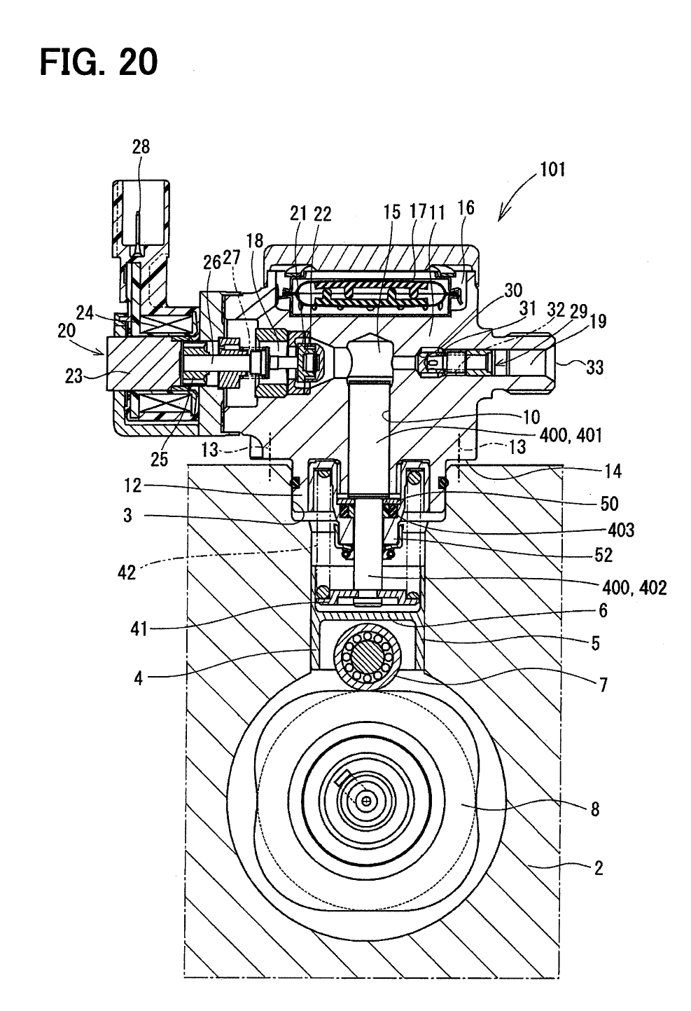

A first comparative example is described with reference to FIG. 20. A plunger 400 of a high-pressure pump 101 according to the first comparative example includes a large column portion 401 having a large diameter, and a small column portion 402 having an outside diameter smaller than an outside diameter of the large column portion 401. The large column portion 401 is inserted into the cylinder 10. The small column portion 402 protrudes to the side, opposite to the pressure chamber 15, of the cylinder 10. The plunger 400 includes a step 403 at a connection portion between the large column portion 401 and the small column portion 402.

The spacer 50 having an annular shape and provided at the end of the cylinder 10 on the side opposite to the pressure chamber 15 has an inside diameter corresponding to an inside diameter of the small column portion 402 of the plunger 400. According to the high-pressure pump 101 of the first comparative example, therefore, the step 403 of the plunger 400 is engaged with the spacer 50 in a state before attached to the internal combustion engine. Accordingly, separation of the plunger 400 from the cylinder 10 is avoidable.

In general, the plunger 400 of the high-pressure pump 101 is pressed in a rotation direction of the cam 8 during reciprocation of the plunger 400 within the cylinder 10 by rotation of the cam 8. Accordingly, the plunger is inclined during reciprocation within the cylinder. The high-pressure pump 101 of the first comparative example includes the step 403 at the connection portion between the large column portion 401 and the small column portion 402, and therefore a corner of the step comes into contact with the inner wall of the cylinder. In this case, reaction force acting on the contact portion increases in accordance with a rise of the plunger even when pressing force of the cam is constant. On the other hand, the plunger 40 according to the first embodiment contacts the inner wall of the cylinder at a corner of the cylinder end. In this case, reaction force acting on the contact portion decreases in accordance with a rise of the plunger when pressing force of the cam is constant. Accordingly, seize resistance of the plunger 400 included in the high-pressure pump 101 of the first comparison example may deteriorate in comparison with the plunger 40 of the first embodiment.

### Second Comparison Example

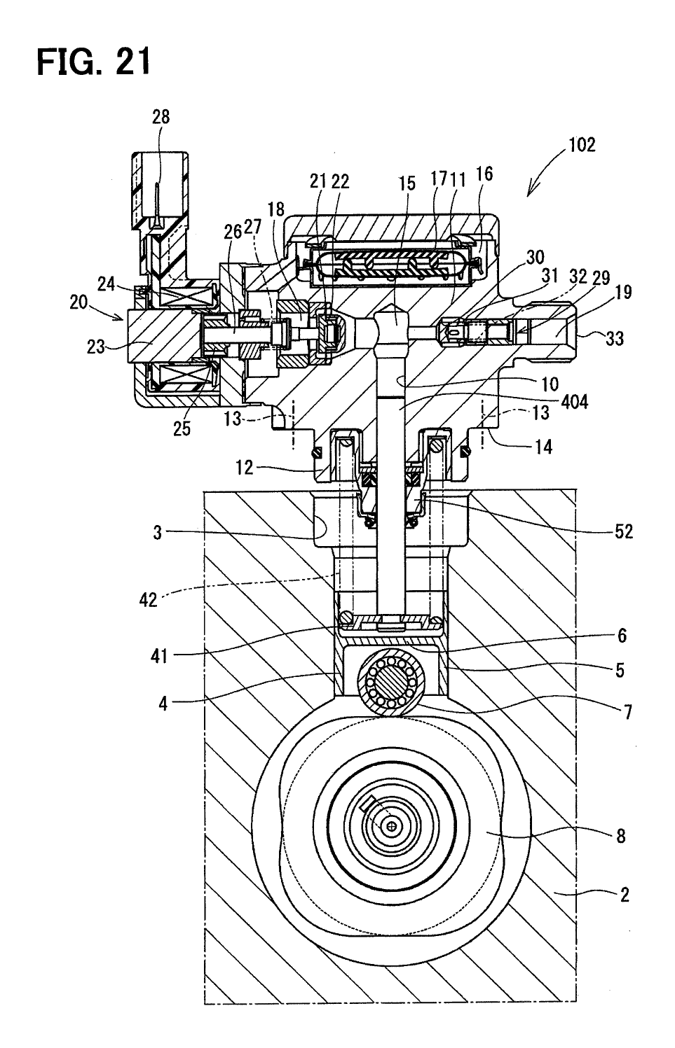

A second comparative example is now described with reference to FIG. 21. A plunger 40 of a high-pressure pump 102 according to the second comparative example is configured by a so-called straight plunger 404 having a constant outside diameter in the axial direction, similarly to the plunger 40 of the first embodiment. However, the high-pressure pump 102 of the second comparative example does not have a configuration for preventing separation of the straight plunger 404. In this case, the plunger spring 42 extends to a free length at the time of attachment of the high-pressure pump 102 to the bore 3 of the internal combustion engine, and therefore fastening of the pump body 11 by the bolt is performed in a state that the fitting portion 12 of the pump body 11 is not fitted to the bore 3. The high-pressure pump 102 therefore simultaneously requires an operation for compressing the plunger spring 42 and fitting the fitting portion 12 of the pump body 11 into the bore 3, and an operation for fastening the pump body 11 to the engine block 2 by the bolt. Accordingly, work efficiency may deteriorate.

### Second Embodiment

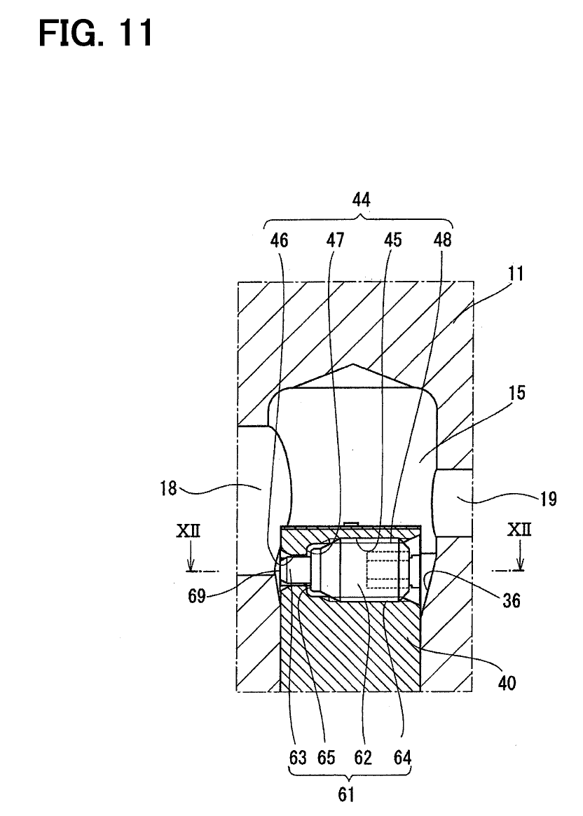

A second embodiment of the present disclosure is hereinafter described with reference to FIGS. 11 to 15.

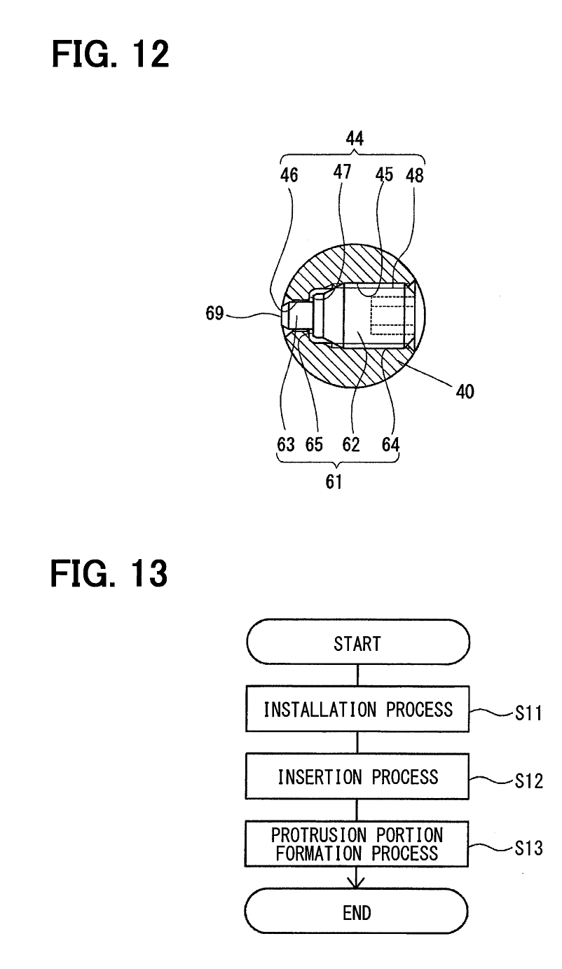

According to the second embodiment, a screw hole 44 is formed at the end of the plunger 40 protruding to the pressure chamber 15 as illustrated in FIGS. 11 and 12. The screw hole 44 includes a large cylindrical portion 45 having a large inside diameter, and a small cylindrical portion 46 having an inside diameter smaller than the inside diameter of the large cylindrical portion 45. The screw hole 44 further includes a step 47 between the large cylindrical portion 45 and the small cylindrical portion 46. A female screw 48 is formed in an inner wall of the large cylindrical portion 45.

A screw 61 which is a column-shaped member is screwed to the inside of the screw hole 44 of the plunger 40. The screw 61 includes a large diameter portion 62 screwing to the female screw 48 of the large cylindrical portion 45, and a small diameter portion 63 inserted into the small cylindrical portion 46. A male screw 64 screwing to the female screw 48 formed in the inner wall of the large cylindrical portion 45 is formed in an outer wall of the large diameter portion 62. The screw 61 further includes a contact surface 65 between the large diameter portion 62 and the small diameter portion 63. As illustrated in FIG. 15, the small diameter portion 63 of the screw 61 protrudes from the small cylindrical portion 46 to the outside of the outer wall of the plunger 40 in a state that the contact surface 65 of the screw 61 contacts the step 47 of the screw hole 44 of the plunger 40.

The portion 69 configured by this protrusion portion corresponds to the “protrusion portion”.

The protruding amount of the portion 69 of the small diameter portion 63 protruding from the outer wall of the plunger 40 to the outside is regulated by the contact between the step 47 of the screw hole 44 and the contact surface 65 of the screw 61. The small diameter portion 63 protrudes to the outside from the inner circumference of the cylinder 10 in such an extent as not to contact the inner wall of the pressure chamber 15. In this case, the small diameter portion 63 of the screw 61 is engaged with the step portion 36 connecting the cylinder 10 and the pressure chamber 15 in a state before attachment of the high-pressure pump 1 to the inner combustion engine. Accordingly, prevention of separation of the plunger 40 from the cylinder 10, and retention of a compressed state of the plunger spring 42 are both achievable.

A production method of the high-pressure pump 1 is now described with reference to FIGS. 13 to 15.

An installation process of S11 and an insertion process of S12 are similar to the corresponding processes described in the first embodiment. During the insertion process, the screw 61 is accommodated in the screw hole 44 of the plunger 40 without protruding to the outside from the outer wall of the plunger 40.

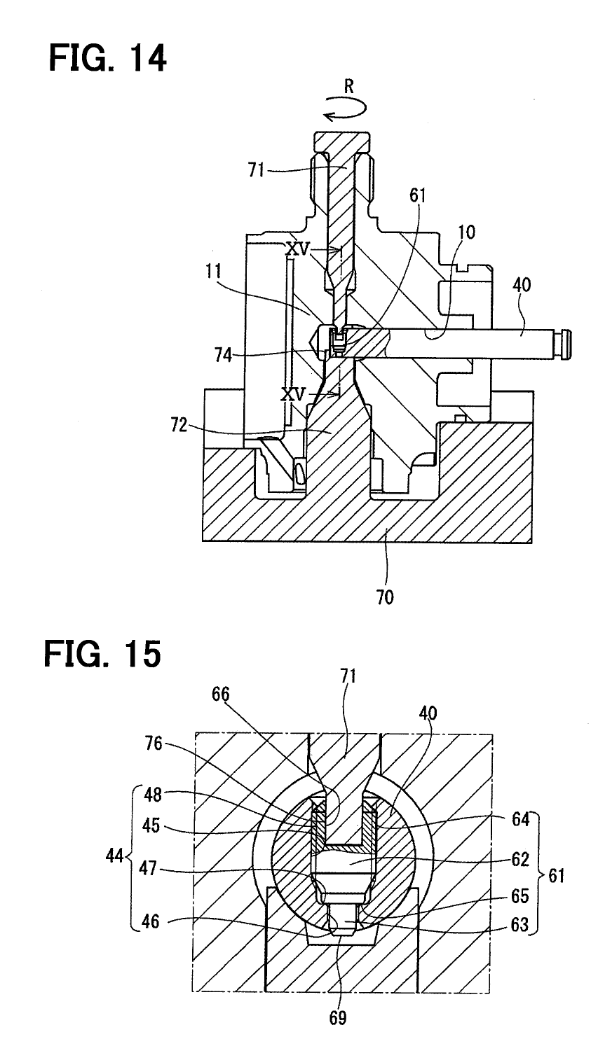

In a protrusion portion formation process of S13, the first jig 71 is inserted from the discharge path 19 toward the pressure chamber 15 as illustrated in FIG. 14.

According to the second embodiment, a tip 76 of the first jig 71 has a prism shape such as a hexagonal prism shape and a quadrangular prism shape as illustrated in FIG. 15. The tip 76 of the first jig 71 is capable of fitting to a square hole 66 formed in the large diameter portion 62 of the screw 61. Accordingly, the screw 61 rotates by rotation of the first jig 71 around the axis as indicated by an arrow R in FIG. 14 under engagement between the tip 76 of the first jig 71 and the square hole 66 of the screw 61, and then the small diameter portion 63 of the screw 61 protrudes in one radial direction from the outer wall of the plunger 40 in the protrusion portion formation process. In this case, the protruding amount of the small diameter portion 63 is regulated by contact between the step 47 of the screw hole 44 and the contact surface 65 of the screw 61.

Thereafter, the high-pressure pump 1 is attached to the bore 3 formed in the engine block 2 of the internal combustion engine.

Following advantageous effects are offered in the second embodiment.

(1) According to the high-pressure pump 1 of the second embodiment, the screw 61 provided at the end of the plunger 40 on the pressure chamber 15 side protrudes in one radial direction from the outer wall of the plunger 40 to the outside of the inner circumference of the cylinder 10.

In this case, the screw 61 is engaged with the step portion 36 formed between the cylinder 10 and the pressure chamber 15 in a state before attachment of the high-pressure pump 1 to the internal combustion engine. Accordingly, separation of the plunger 40 from the cylinder 10 is avoidable. Assembly to the pump body 11 of the high-pressure pump 1 is therefore allowed in a state that the plunger spring 42 is compressed by a predetermined amount.

(2) According to the high-pressure pump 1 of the second embodiment, the screw 61 which is the column-shaped member is screwed to the screw hole 44 formed at the end of the plunger 40 on the side protruding to the pressure chamber 15.

Accordingly, the screw 61 is easily fixed to the plunger 40.

(3) According to the high-pressure pump 1 of the second embodiment, the protruding amount of the screw 61 protruding to the outside from the outer wall of the plunger 40 is regulated by contact between the step 47 formed in the inner wall of the screw hole 44 and the contact surface 65 of the screw 61.

In this case, the protruding amount of the screw 61 is accurately regulated. Accordingly, contact between the inner wall of the pressure chamber 15 and the protrusion portion 69 of the screw 61 is avoidable when the high-pressure pump 1 is used.

(4) According to the production method of the high-pressure pump 1 of the second embodiment, the screw 61 is protruded by a predetermined amount from the screw hole 44 of the plunger 40 to the outside of the plunger 40 by rotation of the first jig 71 in the protrusion portion formation step.

Accordingly, the protrusion portion 69 configured by the screw 61 is easily formed on the outer wall of the plunger 40.

### Third Embodiment

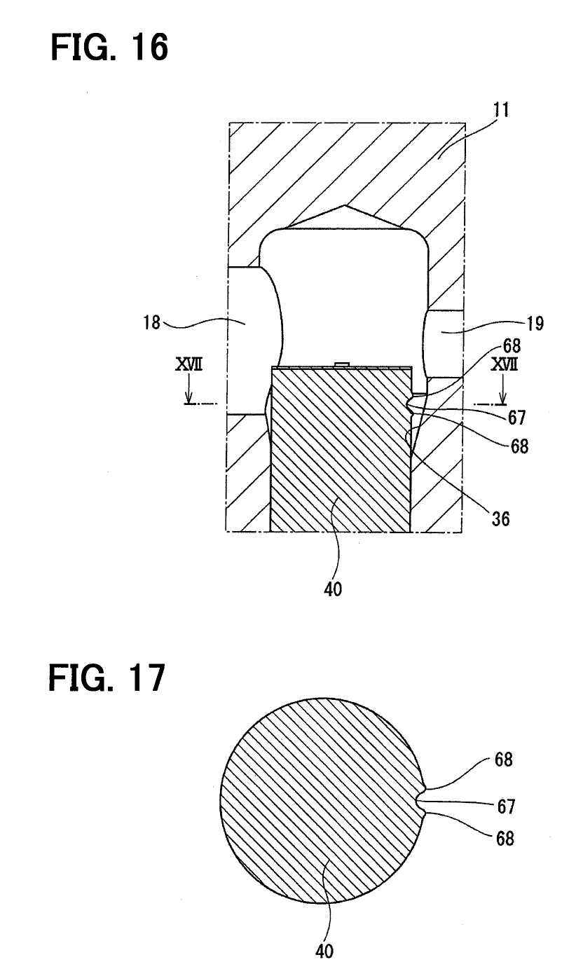

A third embodiment of the present disclosure is hereinafter described with reference to FIGS. 16 to 19.

According to the third embodiment, a protrusion portion 68 is formed around a recess 67 at the end of the plunger 40 on the side protruding to the pressure chamber 15 as illustrated in FIGS. 16 and 17. The protrusion portion 68 may be annularly formed around the recess 67, or may be formed only in a part around the recess 67.

The protrusion portion 68 corresponds to the “protrusion portion”.

The protrusion portion 68 protrudes to the outside from the inner circumference of the cylinder 10 to such an extent as not to contact the inner wall of the pressure chamber 15. The protrusion portion 68 is therefore engaged with the step portion 36 connecting the cylinder 10 and the pressure chamber 15 in a state before attachment of the high-pressure pump 1 to the inner combustion engine. Accordingly, prevention of separation of the plunger 40 from the cylinder 10, and retention of a compressed state of the plunger spring 42 are both achievable.

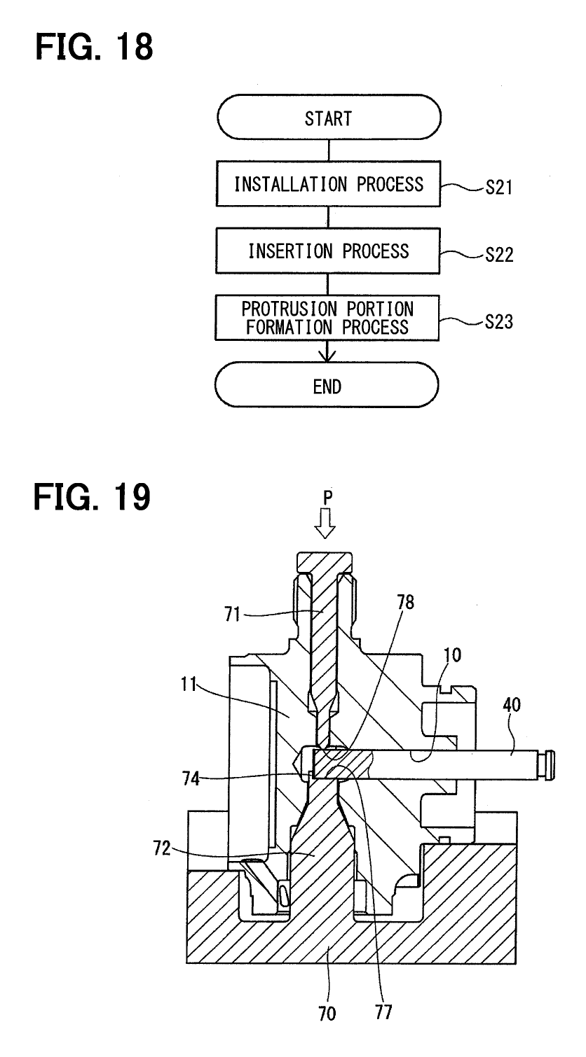

A production method of the high-pressure pump 1 is now described with reference to FIGS. 18 and 19.

An installation process of S21 and an insertion process of S22 are similar to the corresponding process described in the first embodiment. During the insertion process, the plunger 40 has a cylindrical shape and does not include the protrusion portion 68 on the outer wall of the plunger 40.

According to the third embodiment, an end 77 of the second jig 72 on the pressure chamber 15 side has a circular-arc shape capable of contacting the radially outer wall of the plunger 40 as illustrated in FIG. 19. Accordingly, the end 77 of the second jig 72 and the radially outer wall of the plunger 40 come into contact with each other in the insertion step.

In the protrusion formation process in S3, the first jig 71 is inserted from the discharge path 19 toward the pressure chamber 15 to press the plunger 40 by the tip 78 of the first jig 71 as indicated by an arrow P in FIG. 19. In this case, the end 77 of the second jig 72 holds the surface of the plunger 40 on the side opposite to the first jig 71.

According to the third embodiment, a tip 78 of the first jig 71 has a tapered shape such as a conical shape and a pyramid shape. A distal end of the tip 78 of the first jig 71 is rounded. Accordingly, the recess 67 of the plunger 40, and the protrusion portion 68 around the recess 67 are formed by the press of the tip 78 of the first jig 71 against the plunger 40 in the protrusion portion formation process.

Thereafter, the high-pressure pump 1 is attached to the bore 3 formed in the engine block 2 of the internal combustion engine.

Following advantageous effects are offered in the third embodiment.

(1) According to the high-pressure pump 1 of the third embodiment, the protrusion portion 68 is formed around the recess 67 formed at the end of the plunger 40 on the side protruding to the pressure chamber 15.

This configuration forming the protrusion portion 68 and the plunger 40 integrally with each other decreases the number of parts, and also facilitates formation of the protrusion portion 68 on the plunger 40.

(2) According to the production method of the high-pressure pump 1 of the third embodiment, the plunger 40 is held by the second jig 72 in the protrusion portion formation process.

Accordingly, deformation of the plunger 40 by pressing force of the first jig 71 is avoidable during formation of the protrusion portion 68 on the plunger 40.

### Other Embodiments

(1) According to the high-pressure pump 1 described in the plurality of embodiments, the pressure chamber 15 on the side opposite to the plunger 40 is closed by the pump body 11. However, the suction valve unit 20, the discharge valve unit 29 or the like of the high-pressure pump 1 in another embodiment may be detachably attached to the pressure chamber 15 on the side opposite to the plunger 40.

(2) According to the plurality of embodiments described herein, the discharge path 19 is a “fuel path”, and the supply path 18 is a “second fuel path”. However, the supply path 18 may be provided as the “fuel path”, and the discharge path 19 may be provided as the “second fuel path” in another embodiment. Alternatively, a relief path or the like communicating with the pressure chamber 15 may be provided as the “fuel path” or the “second fuel path”, in place of the discharge path 19 and the supply path 18.

(3) According to the second embodiment described herein, the protruding amount of the screw 61 is regulated by the contact between the step 47 formed in the inner wall of the screw hole 44 of the plunger 40, and the contact surface 65 included in the screw 61. However, in another embodiment, the protruding amount of the pin 60 may be regulated by contact between a step formed in the inner wall of the hole 43 of the plunger 40 described in the first embodiment, and a contact surface formed at an intermediate portion of the pin 60 in the axial direction.

Accordingly, the present disclosure is not limited to the embodiments described herein, but may be practiced in various other modes without departing from the scope of the invention, as well as combinations of the plurality of embodiments described herein.

1. A high-pressure pump comprising:
a cylinder;
a pump body including a pressure chamber having a larger inside diameter than an inside diameter of the cylinder, the pressure chamber provided in a deep portion of the cylinder;
a plunger that reciprocates within the cylinder to vary a volume of the pressure chamber;
a fuel path formed in the pump body so as to extend in a radial direction of the cylinder from the pressure chamber; and
a protrusion portion protruding in one radial direction from an end of the plunger in the pressure chamber to the outside of an inner circumference of the cylinder.

2. The high-pressure pump according to claim 1, wherein:
the cylinder and the pump body are formed integrally; and
the pump body closes the pressure chamber on a side opposite to the plunger.

3. The high-pressure pump according to claim 1, wherein:
the protrusion portion is a column-shaped member fixed to a hole or a screw hole formed at the end of the plunger on a side protruding to the pressure chamber.

4. The high-pressure pump according to claim 3, wherein:
the column-shaped member is a pin press-fitted and fixed to the hole formed at the end of the plunger on the side protruding to the pressure chamber.

5. The high-pressure pump according to claim 3, wherein:
the column-shaped member is a screw screwed to the screw hole formed at the end of the plunger on the side protruding to the pressure chamber.

6. The high-pressure pump according to claim 3, wherein:
the column-shaped member includes a contact surface in contact with a step formed in an inner wall of the hole or the screw hole of the plunger; and
a protruding amount of the column-shaped member protruding to the outside from an outer wall of the plunger is regulated by contact between the step and the contact surface.

7. The high-pressure pump according to claim 1, wherein:
the protrusion portion is formed around a recess formed at the end of the plunger on a side protruding to the pressure chamber.

8. A production device for producing the high-pressure pump according to claim 1, the production device comprising:
an installation table on which the pump body is installed; and
a first jig inserted from the fuel path toward the pressure chamber to form the protrusion portion at the end of the plunger on the side protruding to the pressure chamber.

9. The production device according to claim 8, further comprising:
a second jig inserted into the pressure chamber from a second fuel path formed in the pump body and different from the fuel path into which the first jig is inserted, wherein:
the second jig includes a positioning portion in contact with an axial end of the plunger.

10. The production device according to claim 9, wherein:
the second jig has a recess portion regulating the protruding amount of the protrusion portion protruding to the outside from the outer wall of the plunger.

11. A production method for producing the high-pressure pump according to claim 1, the production method comprising:
an installation process for installing the pump body on an installation table;
an insertion process for inserting the plunger into the cylinder; and
a protrusion portion formation process for inserting a first jig from the fuel path toward the pressure chamber to form the protruding portion at the end of the plunger on the side protruding to the pressure chamber.

12. The production method of the high-pressure pump according to claim 11, wherein:
the protrusion portion is a column-shaped member fixed to a hole or a screw hole formed at the end of the plunger on the side protruding to the pressure chamber; and
in the protrusion portion formation process, the column-shaped member is protruded by a predetermined amount from the hole or the screw hole of the plunger to the outside of the plunger by a press or rotation of a first jig.

13. The production method of the high-pressure pump according to claim 11, wherein:
an axial position of the plunger is determined by inserting a second jig into the pressure chamber from a second fuel path different from the fuel path into which the first jig is inserted, and bringing the plunger and a positioning portion included in the second jig into contact with each other in the insertion process.

14. The production method of the high-pressure pump according to claim 11, wherein:
a protruding amount of the protrusion portion is regulated by inserting a second jig into the pressure chamber from a second fuel path different from the fuel path into which the first jig is inserted, and bringing the protrusion portion into contact with a recess portion included in the second jig in the protrusion portion formation step.

15. The production method of the high-pressure pump according to claim 11, wherein:
the plunger is held by a second jig inserted toward the pressure chamber from a second fuel path different from the fuel path into which the first jig is inserted in the protrusion portion formation step.
